(19) United States
(12) Patent Application Publication
(10) Pub. No.: US 2004/0201745 A1
(43) Pub. Date: Oct. 14, 2004

(54) Camera using a memory card with an integrated electronic imager for digital capture

(75) Inventors: Raymond E. Wess, Holley, NY (US); John R. Fredlund, Rochester, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 09/966,274

(22) Filed: Sep. 28, 2001

(51) Int. Cl. H04N 5/262

(52) U.S. Cl. 348/231.7

(57) ABSTRACT

A camera is adapted for electronically capturing an image by using a memory card that includes an integrated image sensor and a memory device for storing images captured by the image sensor when it is located in an optical path inside the camera. In one embodiment, the camera includes a film drive for positioning a photographic film in a first image exposure plane within the camera enclosure; an optical system defining an optical path for forming the image on the first image plane; a receptacle for receiving the removable memory card through an exterior opening in the enclosure and guiding the memory card into the optical path. The presence of the memory card in the receptacle is sensed and a camera control stage then adjusts the optical system to form the image at a second image plane on the surface of the image sensor and disables the film drive, thereby preventing the film from being advanced when the image sensor is used to capture the image.

### FIELD OF THE INVENTION

The invention relates generally to the field of photography, and in particular to photographic cameras that are capable of capturing both film and digital images.

### BACKGROUND OF THE INVENTION

Hybrid photographic cameras, which are well known, are capable of simultaneously capturing an image on both a photographic film and an electronic image sensor, such as a CCD or CMOS sensor. One of the principal advantages of the electronic capture is to verify and preview the film capture, which of course cannot be visibly rendered until the film is removed and developed (see, e.g., the Kodak Advantix Preview Camera). The two capture devices may be aligned with respect to the same input optical path using, for example, a beamsplitter to separate the two devices, or the two capture devices may be aligned with respect to two separated optical paths that substantially view the same subject. In either case, the requirement for two specialized image capture events ordinarily results in a more expensive, and sometimes a somewhat larger, piece of photographic equipment than a film camera by itself. In addition, the photographer must invest in, and carry around, a camera having both capabilities even though one or the other capability, e.g., the digital capture, may be only infrequently used. If the digital capture is specifically intended for preview, costs may be held in line with a low resolution imager, but this compromises the use of the digital imager as a source of higher resolution images for other purposes, such as storage of the images and their subsequent use for transmission, e-mail, hard copy prints, and the like.

Consequently, it would be advantageous to employ conventional photographic film cameras to capture digital images only when so desired. If traditional film cameras could be so employed with an “electronic film” in place of the conventional film, a photographer could easily convert an existing film camera into a digital camera only when needed, all the while taking advantage of the many features which film cameras economically provide, such as the wider availability of higher quality optics, interchangeable lenses, more elaborate exposure and focus modes, and in general a more convenient size and weight factor. Importantly, such a camera retains the option of using conventional photographic film (e.g., to obtain a higher resolution image at much less cost) as well as obtaining the benefits of electronic capture when desired (e.g., more immediate rendering of an image, transmission and sharing, more immediate image processing, and the like).

This advantage is related to camera systems that capture images on either photographic film or with an electronic imaging device. A number of solutions already available include those offered by SiliconFilm and Imagek.

Both systems are for 35 mm cameras where the electronic imager sensing unit fits into the same film cassette location and gate as a 35 mm film cassette. As another example, in U.S. Pat. No. 6,181,883 a digital image capture module is deployed for use with a photographic film camera in place of the photographic film that would ordinarily be loaded into the camera. The module is designed to be the same size (form factor) as a conventional 35 mm film cartridge so that it mechanically fits in the space inside a standard 35 mm camera where a conventional 35 mm film cartridge is loaded. In particular, a thin CMOS image sensor is supported on a thin substrate that is squeezed against the film rails of the camera when its back is closed. Auxiliary electronics may be designed to fit in the space where conventional film is attached to its take-up spool.

In U.S. Pat. No. 6,278,481, which shows a similar kind of digital module for use in the film chamber of a film camera, it is further disclosed that different embodiments of the module allows different numbers of exposures or images to be stored. Further, the module can be configured to generate different resolutions (i.e., number of pixels per image) of images as well as the number of bits per pixel. The resolution can be configured to vary according to the embodiment of the module used. A drawback with these “electronic film” systems is the very convertibility that makes them attractive in the first place, that is, since the digital module conveniently occupies the space where the film would be, the film has to be removed in order to capture digital images. Consequently, important pictorial moments may be lost to film, if the digital module is being used, and vice versa.

One approach to this problem is shown in U.S. Pat. No. 5,493,353, which describes a dual video and still film camera in which the film does not need to be removed, although both capture devices are positioned for arrangement in the same optical path. By means of a manual or automatic adjustment, the photographer can extend the digital image sensor into the image line of sight in order to activate video operation or can retract the image sensor in order to allow still film operation unimpeded by the video apparatus. The disadvantage of this dual camera is its dual requirement of two capture systems and all their supporting components, as well as a special body enclosure to contain and protect the digital image sensor, including the mechanical track and gearing for its retraction in and out of the optical path, which increases the size of the camera body. In many respects, this design retains the drawbacks of hybrid cameras without offering their advantage, namely, simultaneous capture for preview and verification. Moreover, the advantage of deploying different types of modules is not realized.

What is needed is a way to incorporate a digital module into the optical path of a film camera without either requiring removal of the film or the continuous possession of a digital capture capability in the film camera body.

### SUMMARY OF THE INVENTION

The present invention is directed to overcoming one or more of the problems set forth above. Briefly summarized, according to one aspect of the present invention, a film camera is adapted for electronically capturing an image by using a memory card that includes an integrated image sensor and a memory device for storing images captured by the image sensor when it is located in an optical path inside the camera. The camera includes a film drive for positioning a photographic film in a first image exposure plane within the camera enclosure; an optical system defining an optical path for forming the image on the first image plane; a receptacle for receiving the removable memory card through an exterior opening in the enclosure and guiding the memory card into the optical path. The presence of the memory card in the receptacle is sensed and a camera control stage then adjusts the optical system to form the image at a second image plane on the surface of the image sensor and disables the film drive, thereby preventing the film from being advanced when the image sensor is used to capture the image.

The invention also pertains to a memory card conforming to a compact flash card standard and usable with an electronic camera that includes a flash card interface, wherein the memory card includes an image sensor and a flash memory device both integrated on the card for capturing and storing one or more images when the card is inserted into an electronic camera and the image sensor is located in an optical path in the camera.

The invention further pertains to a digital camera that includes a camera enclosure; an optical system including one or more lens elements defining an optical path for forming an image; a receptacle within the enclosure for receiving a removable memory card through an exterior opening in the enclosure and guiding the memory card into the optical path, wherein said memory card includes an integrated image sensor and memory device for storing one or more images captured by the image sensor when it is located in the optical path; means for sensing the presence of the memory card in the receptacle with the image sensor in the optical path; and a camera control stage responsive to the sensing means for controlling operation of the camera.

Besides the advantage of offering a dual capture function in a film camera, the other advantages of the invention include the following:

Dual function flash memory electronic imager card.

The camera can contain both film and the flash memory electronic imager card at the same time.

The camera never needs to be connected to a computer.

Electronic image resolution can be increased by inserting a different card with a higher pixel count imager.

The electronics to drive the flash memory electronic imager are contained in the camera.

The electronic imaging device can be buffered to the flash memory directly on the card.

Flash memory electronic imager cards can be used in any electronic camera that accepts standard compact flash image capture cards.

In a solely digital camera environment, the advantage is that the digital camera can use sensors of different resolutions. The memory card would indicate to the camera the resolution, size, and aspect ratio of the particular imaging sensor on the card, which would enable the digital camera to make the necessary adjustments, e.g., correct object to image plane conjugate adjustments, for any size memory card sensor.

These and other aspects, objects, features and advantages of the present invention will be more clearly understood and appreciated from a review of the following detailed description of the preferred embodiments and appended claims, and by reference to the accompanying drawings.

### BRIEF DESCRIPTION OF THE E DRAWINGS

FIG. 1 is an isometric view of a film camera using a memory card for digital capture according to the invention.

FIG. 2 is a diagram of a system employing the camera shown in FIG. 1.

FIG. 3 is an internal view taken from the bottom of the camera shown in FIG. 1 and showing the internal components for supporting and interfacing with the memory card inside the camera.

FIG. 4 is a block diagram of the electronic components of the memory card shown in FIG. 1.

FIG. 5 is a diagram of a further embodiment of the invention, showing insertion of an image card from the side wall of the camera.

FIGS. 6A and 6B shows the operation of a mode select button on the camera, which controls the position of a light tight baffle that moves in front of the film before the memory card is inserted into the camera.

### DETAILED DESCRIPTION OF THE INVENTION

Because imaging devices employing electronic sensors and photographic film are well known, the present description will be directed in particular to elements forming part of, or cooperating more directly with, apparatus in accordance with the present invention. Elements not specifically shown or described herein may be selected from those known in the art. Certain aspects of the embodiments to be described may be provided in integrated circuitry. Given the system as shown and described according to the invention in the following materials, implementation of the invention in the form of an integrated circuit, such as a conventional memory card, is within the ordinary skill in such arts.

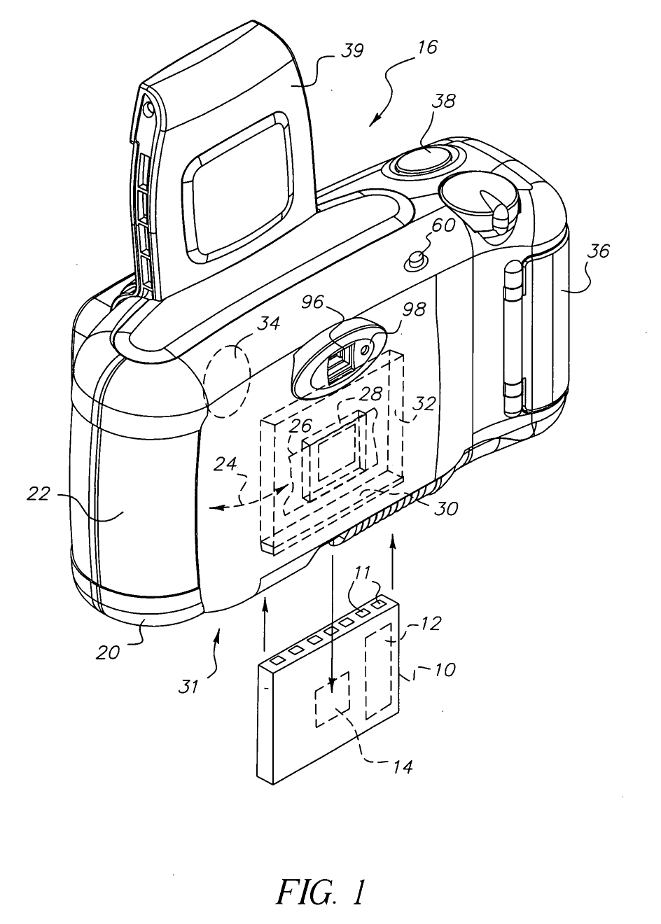

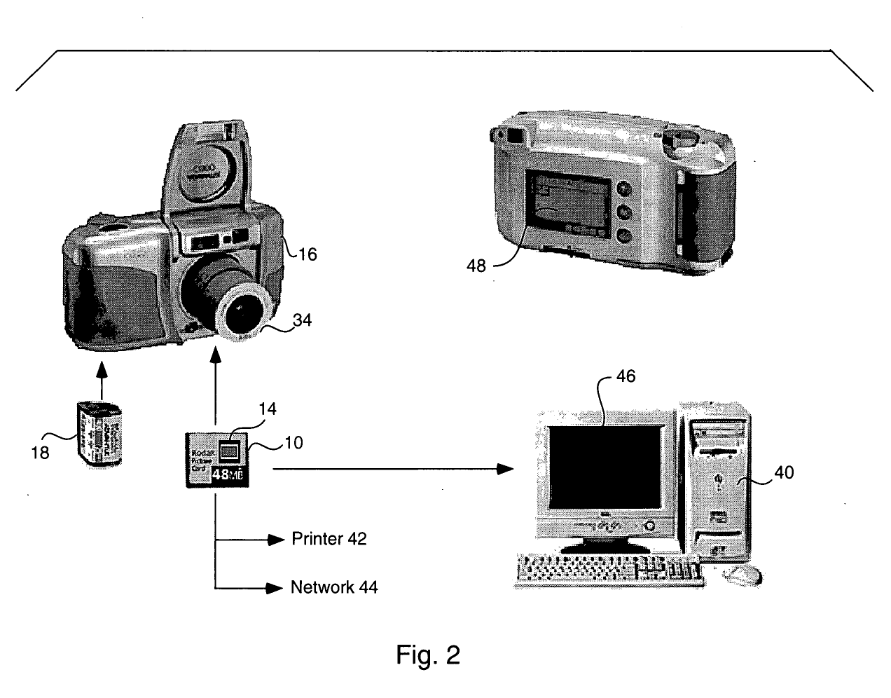

Referring to FIGS. 1 and 2 in combination, the invention includes a memory card 10, containing both a memory 12 and an electronic image capture device 14, and a camera 16 that accepts both traditional film in the conventional manner and the memory card 10 through a slot 30 in the camera body. Preferably, the electronic image capture device 14 is a CMOS image sensor and the memory 12 is a flash memory device, and both are integrated directly onto the same card substrate. However, other imaging devices, such as a CCD image sensor, and other types of memory may be employed on the card. In the preferred embodiment, and as shown in the illustrations, the camera 16 is based on an Advanced Photo System (APS) film camera of the type commonly offered by Eastman Kodak Company, although the invention may be employed with other film format cameras, such as a 35 mm camera. In the APS camera 16, a film cartridge 18 is loaded through a film door 20 into a film chamber 22 and a film strip 26 is advanced (in the direction of an arrow 24) past a film gate 28, where the film strip 26 is exposed to image light and pictures are taken in the traditional manner.

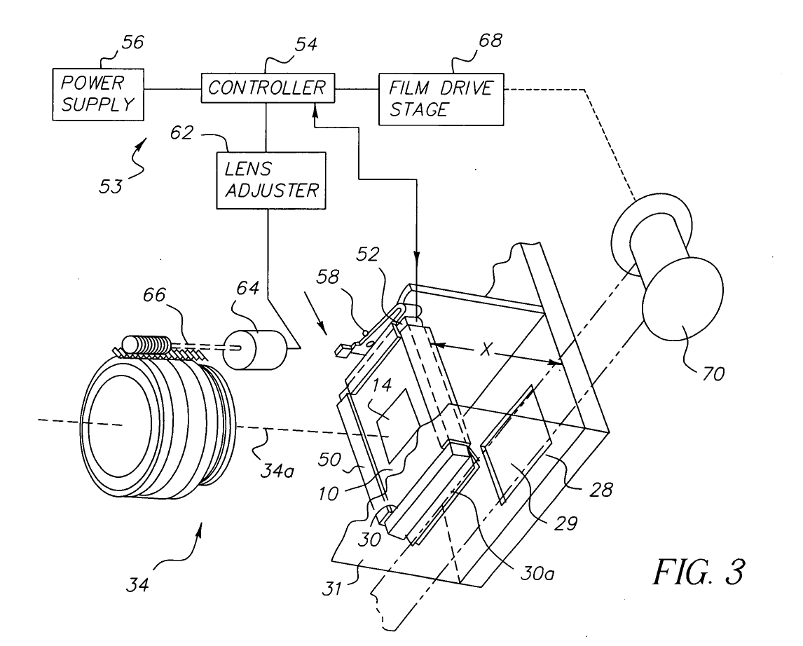

When it is desired to capture one or more electronic images, the memory card 10 is slid through the slot 30 on a bottom plate 31 of the camera 16 into a receptacle 32 arranged inside the camera in front of the film gate 28. The receptacle 32 and the memory card 10 cooperate to form a light tight barrier between a camera lens 34 and the film gate 28. The memory card 10 includes electrical contacts 11 that engage corresponding contacts in the camera and connect with internal control components within the camera (these interfaces will be further described in connection with FIG. 3). For instance, the camera 16 senses that the memory card 10 has been inserted and automatically switches modes from a film capture mode to an electronic image capture mode. In the electronic image capture mode, the camera lens 34 is automatically moved to achieve the proper object to image plane conjugates for the position of the image sensor 14. The camera 16 also includes a battery power supply in a battery compartment 36 and a shutter release 38 to initiate an exposure in either mode.

As shown in FIGS. 1 and 2, a flash unit 39 has been raised, which also provides protection for the lens and generally disables the camera when closed.

As shown in FIG. 2, after an image is captured electronically, the memory card 10 can be ejected and inserted into a standard compact flash card 10 reader attached to a computer 40, or the card 10 can be interfaced with another utilization device, such as a printer 42 or a computer appliance 44 providing an Internet connection. Images from the card are then downloaded from the card 10 to the utilization device, such as the computer 40. Since the camera is basically a film camera doubling as a digital camera, the camera may be used to capture film images while downloading the digital images. A display 46 on the computer may be used to review the digital images; in addition, a display 48 may be provided on the back of the camera and employed to display a captured digital image when the camera is in the electronic capture mode. Since the image sensor 14 is integrated into the image capture card, different capture functionalities may be provided by different cards. For example, if the image review suggests retaking the picture at a higher resolution, the digital image resolution may be upgraded by using an memory card with a higher resolution sensor. Other functionalities could be provided: a monochrome card, a custom spectrally-responsive card (e.g., an infrared card), a card that includes audio (which would require appropriate modification of the camera to pick up speech), and so on. The memory card 10 may also be used to upload data related to film capture as well. Annotation data created on a computer (PC) could be uploaded through the memory card interface, and the data may then be written to the magnetic layer on the APS film. This would allow the user to upload custom annotation for a given film frame. Zoom and crop information, print order and other data related to photofinishing could be conveyed to the film through the memory card interface as well.

FIG. 3 shows a detailed view of the mechanical and electrical interface between the memory card 10 and the camera 16, as seen from the bottom plate 31 of the camera. The slot 30 through which the memory card 10 is inserted is normally covered by a door 30a, which is opened to insert the memory card 10 when the camera 16 is set for the electronic image capture mode. The memory card 10 is inserted through the slot 30 and along the rails 50 which define the edges of the receptacle 32. The rails 50 are precisely positioned to hold the CMOS image sensor 14 in a capture position intersecting an optical axis 34a of the lens 34. When fully inserted, the connectors 11 on the memory card 10 engage a card connector block 52, which electrically connects the memory card 10 to a camera control stage 53, in particular to a controller 54. The presence of the fully inserted memory card 10 is signaled to the controller 54, e.g., through electrical engagement of one or more of the electrical connectors 11, through mechanical engagement with a microswitch (not shown) on the receptacle frame, or any like kind of indication.

In the preferred embodiment, the camera control stage 53 also includes a power supply 56 (e.g., batteries in the battery compartment 36), which is used to power the electrical components in the memory card 10; furthermore, the controller 54 provides the appropriate clocking signals directly to the memory card 10 for clocking an image signal from the CMOS image sensor 14 to the flash memory on the card. The controller 54 could also appropriately drive the CMOS 20 sensor 14 to provide electronic shuttering action; this may be especially useful if the camera shutter is behind the inserted memory card 10, where it is unable to provide exposure time control for the electronic capture mode. When the memory card 10 is fully inserted into the receptacle 32, an end thereof (including the connectors 11) is forced against an eject mechanism 58, which is spring tensioned to eject the card 10 when an eject button 60 on the camera is pressed. The eject mechanism can also be configured to firmly hold the memory card 10 in place in the receptacle so that the image sensor 14 is always positioned correctly in the optical path 34a regardless of the motion imparted to the camera by the user. The eject button 60 would then forcibly release the memory card 10 from the grip of the eject mechanism 58 and push the card toward the slot 30 so that it can be grabbed by the user.

The presence of the fully inserted memory card 10 in the receptacle 32 is sensed by the controller stage 54, which causes certain adjustments to be made. Since the CMOS imager 14 is not located at the film exposure plane 29, but instead a distance x in front of the exposure plane 29, the optical conjugates of the lens 34 must be adjusted to form the image on the CMOS imager 14 (whereupon the autofocus system of the camera will take over and focus the image on the surface of the CMOS sensor). The camera control stage 53 provides this adjustment by a lens adjuster 62, which actuates a gear motor 64 to drive a rack and pinion adjuster 66 attached to the lens 34. The lens 34 (or elements within the lens) is then moved relative to the optical axis 34a until the optical conjugates are appropriately adjusted. The memory card 10 may also indicate to the camera the resolution, size, and aspect ratio of the particular imaging sensor on the card through the electronic interface connector 11. This enables the camera to make the correct object to image plane conjugate adjustments for any size memory card sensor. Another adjustment concerns the film advance, since the shutter release 38 must actuate a digital exposure of the CMOS sensor without causing the film to advance to the next frame. For this purpose, the camera control stage 53 includes a film drive stage 68 for disabling a film drive 70, thereby holding the film strip 26 stationary in the film gate 28.

In the preferred embodiment, the rails 50 (and other frame parts surrounding the inserted card) are constructed to tight tolerances such that they are light tight and prevent unwanted light from entering into the cavity between the inserted memory card 10 and the film gate 28 and thereupon exposing the film. However, since the process of loading the memory card 10 into the camera 16 involves opening the door 30a or otherwise gaining access to the interior of the camera, unwanted light may enter at that time. One way to handle stray light is to provide a light lock in the entry portion of the slot 30. If a shutter (e.g., a focal plane shutter) is already present in close adjacency to the film gate 28, then the film driver stage 68 is further configured to maintain the shutter in its closed position, thereby covering the film exposure plane 29. If the shutter is associated with the lens 34 (e.g., in a shutter/aperture device), then the camera depends upon the aforementioned light lock or includes an auxiliary shutter blade that is closed over the exposure plane 29 before the memory card 10 is loaded into the camera 16. In the latter case, the door 30a could be locked in a closed position during a film capture mode and only unlocked during a digital capture mode. The user could be required to initially select the electronic capture mode, e.g., with a mode select button on the back of the camera, before an interlock on the door 30a would be released and the memory card 10 inserted.

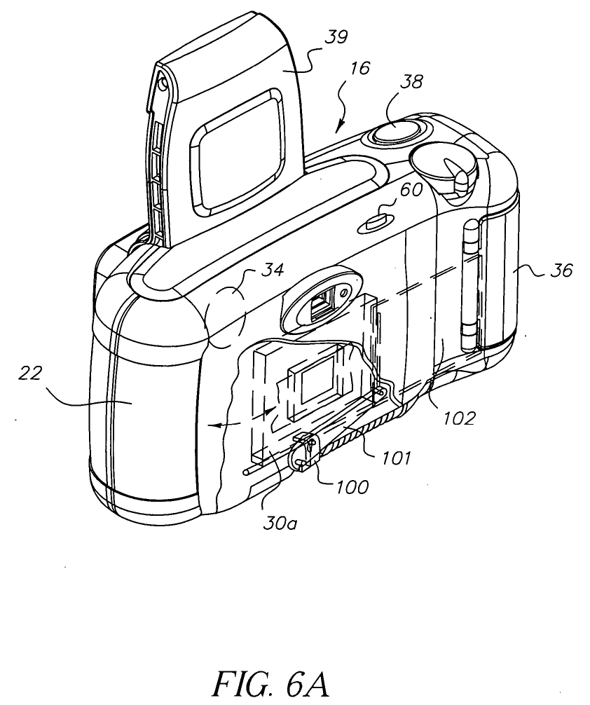

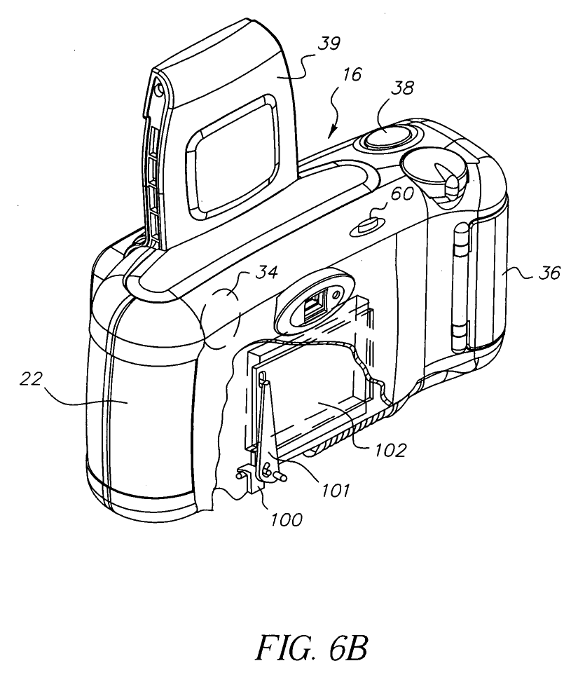

As shown in FIGS. 6A and 6B, the mode select button may be provided as a slide switch 100 that would enable the user to mechanically slide a light tight baffle 102 in front of the film plane before the memory card 10 could be inserted into the camera through an interlocking door 30a. In this embodiment, the slide switch 100 is connected to the light tight baffle 102 through a connecting arm 101 that pivots as the switch 100 is moved from right to left. As the mode switch 100 moves, the pivot arm 101 causes the baffle 102 to move into place. Conversely, the light tight baffle 102 could not be removed by sliding the switch 100 in the opposite direction until the memory card 10 was completely removed allowing the interlocking door 30a to fall back into a light tight condition. FIG. 6B shows the light tight baffle 102 in the closed position.

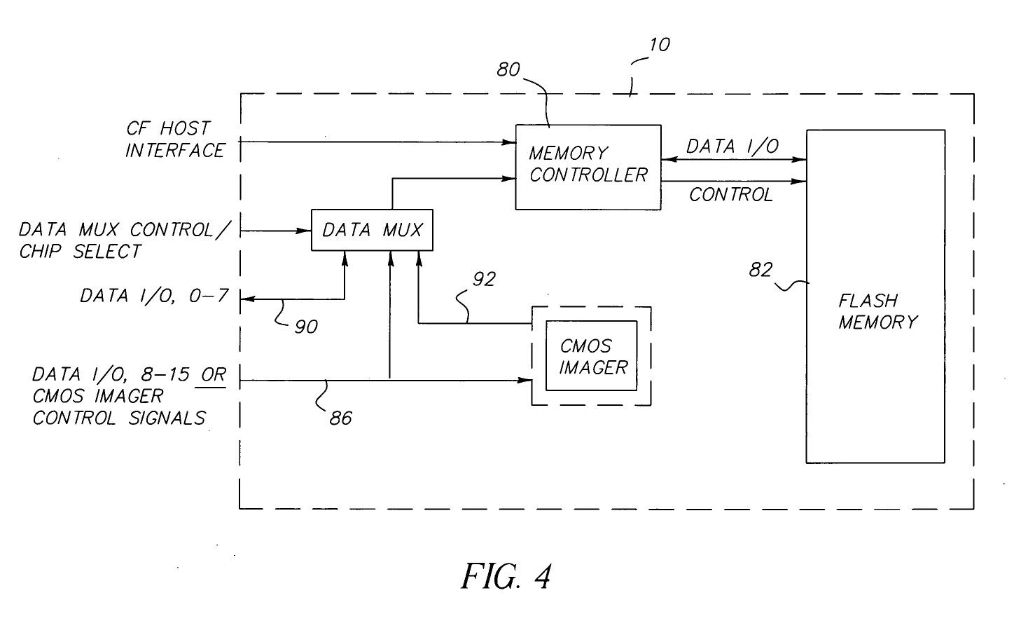

In the preferred embodiment, an industry-standard Compact Flash Card is modified to include an integral CMOS Imager. Such a modified Compact flash card with a CMOS Imager built directly on the card facilitates image transfers directly to flash memory on the card. As shown in FIG. 4, standard Compact Flash (CF) cards currently available have a memory controller 80 and a flash memory bank 82. The card 10 is connected to an external host through a 50 pin host interface 84. The memory controller 80 provides data and error management as well as true IDE mode functionality. The CF card 10 can operate in 8 or 16 bit transfer mode, depending on the host interface.

CMOS imager technology is well suited for integration onto compact flash memory cards because voltage level power requirements are similar to standard CF card requirements. As a result, the CMOS imager 14 can be powered from the power and ground connections available on standard CF cards. Because the camera is providing power and clocking signals to the card, no additional support electronics are needed on the flash card.

Compact flash cards can be used in either 8 or 16 bit transfer modes. When used in the 8 bit mode, 9 data/chip select I/O pins are unused. The CMOS imager 14 requires a number of control lines 86 to operate in addition to power and ground. By using the 8 bit mode, CF I/O pins are freed to be used as control signals for the CMOS imager. If the CF is placed in a system that uses the 16 bit transfer mode, the CMOS imager 14 can be bypassed such that normal 16 bit transfers can take place. In this manner, a CF memory card 10 including an image sensor 14 according to the invention can be used in any electronic camera (with its own digital image sensor) that accepts standard compact flash image capture cards, where the memory will store images from the camera's image sensor while the CMOS sensor on the card is inactive. A data multiplexer 88 is needed to switch between external I/O data 90 and internal data 92 generated by the CMOS imager. By using a data multiplexer 88, additional pins for data transmission are not necessary. The data multiplexing operation could ultimately be incorporated into the memory controller functionality.

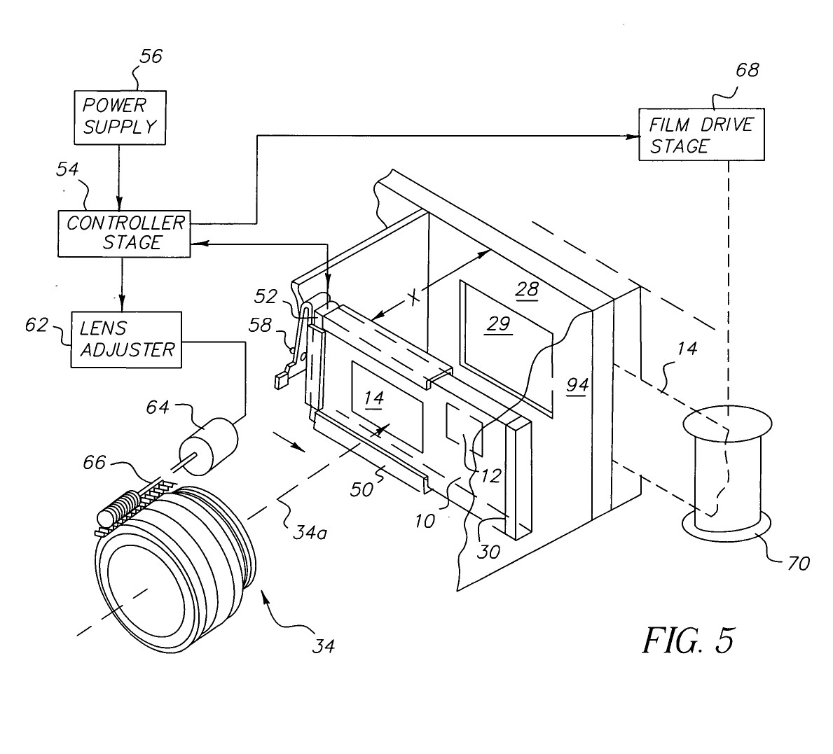

Although the invention has been disclosed for use with APS cameras, it should be understood that it may be employed with other types of cameras, e.g., 35 mm cameras. In such cameras, it may be feasible for the memory card 10 to be inserted from the side of the camera instead of through a bottom wall as shown in FIG. 3. For instance, FIG. 5 is a diagram of a further embodiment of the invention, showing insertion of an image card from a side wall 94 of the camera. In addition, FIG. 5 shows a memory card 10 having a different form factor than that shown in FIG. 3, specifically a more elongated form that permits the card to extend further into the interior of the camera. Moreover, the image card could match other interface standards, such as the PCMCIA standard, or it could be designed for a custom interface.

In a further embodiment of the invention, the presence of the memory card 10 in the camera is signaled to the user, e.g., by a indication or icon in the display of a viewfinder 96 on the camera or by an LED 98 or the like in a position where it would be noticed by the user (such as nearby the viewfinder 96). Such a signal can remind the user that the memory card IO is in the camera, which is particularly useful if the camera has been set aside for awhile and/or the full insertion of the memory card 10 allows the door 30a to close such that there is no exterior reminder as to the presence of the memory card 10. In addition, if the camera is of the type (an SLR) where the lens is removable 34, then the adjustments of the optical conjugates can be obtained by fitting a different lens on the camera (and dispensing with the movement provided by the rack and pinion adjuster 66). The signal in the viewfinder 96 or LED 98 then serves to remind the user that the film camera needs to be made ready for digital capture by, among other things, changing the lens. In this case, it might also be desirable for the user to manually insert a dark slide in front of the film exposure plane (through a light lock, as in a view camera) to prevent unwanted light from reaching the film, and/or to ask the user to manually disengage the film drive during the electronic capture mode.

As heretofore mentioned, the memory card may be a dual card that is doubly useful with a film camera or a digital camera, where the memory card includes a memory controller that senses when the memory card is being used in a digital camera having its own dedicated image sensor, and wherein the memory controller causes the memory device to store images captured by the dedicated sensor rather than the sensor integrated on the memory card. The memory card may also be used in a digital camera where the memory device integrated on the card is used as the image sensor for the digital camera. Essentially, FIG. 1 without provision for the film strip 26 (and without the corresponding film chamber 22 (or the film driver stage 68 and film drive 70 shown in FIG. 3)) would constitute such a digital camera. This allows for a digital camera that can use sensors of different resolutions. The memory card 10 would indicate to the camera the resolution, size, and aspect ratio of the particular imaging sensor on the card through the electronic interface connector 1. This would enable the digital camera to make the necessary adjustments, e.g., the correct object to image plane conjugate adjustments, for any size memory card sensor.

The invention has been described with reference to a preferred embodiment. However, it will be appreciated that variations and modifications can be effected by a person of ordinary skill in the art without departing from the scope of the invention.

### Parts List

10 image capture card

11 connector

12 flash memory

14 electronic image capture device

16 camera

18 film cartridge

20 film door

22 film chamber

24 arrow

26 film strip

28 film gate

29 exposure plane

30 slot

30a interlocking door

31 bottom plate

32 receptacle

34 camera lens

36 battery compartment

38 shutter release

39 flash unit

40 computer

42 printer

44 network

46 computer display

48 camera display

50 rails

52 card connector block

54 controller

56 power supply

58 eject mechanism

60 eject button

62 lens adjuster

64 gear motor

66 rack and pinion adjuster

68 film driver stage

70 film drive

80 memory controller

82 flash memory bank

84 host interface

86 control lines

88 data multiplexer

90 external I/O data

92 internal data

94 side wall

96 viewfinder

98 LED

100 slide switch

101 connecting arm

102 light tight baffle

What is claimed is:

1. A film camera adapted for electronically capturing an image, said camera comprising:
a camera enclosure including a film drive for positioning a photographic film in a first image exposure plane within the enclosure;
an optical system including one or more lens elements defining an optical path for forming the image on the first image plane;
a receptacle within the enclosure for receiving a removable memory card through an exterior opening in the enclosure and guiding the memory card into the optical path, wherein said memory card includes an integrated image sensor and memory device for storing one or more images captured by the image sensor when it is located in the optical path;
means for sensing the presence of the memory card in the receptacle with the image sensor in the optical path; and
a camera control stage responsive to the sensing means for adjusting the optical system to form the image at a second image plane on a surface of the image sensor and for disabling the film drive, thereby preventing the film from being advanced when the image sensor is used to capture the image.

2. The camera as claimed in claim 1 wherein the optical system includes a shutter arranged in the optical path between the receptacle and the first image exposure plane and said camera control stage further disables the shutter so that it remains closed over the first image exposure plane when the memory card is in the receptacle.

3. The camera as claimed in claim 1 wherein the memory card and receptacle form a light tight barrier that prevents exposure of the film when the memory card is fully inserted into the receptacle.

4. The camera as claimed in claim 1 wherein the receptacle includes a light lock at or near the exterior opening in the camera enclosure that prevents unwanted light from entering into the enclosure.

5. The camera as claimed in claim 1 wherein the receptacle includes a light tight baffle that is positioned in front of the first image exposure plane before the memory card is inserted into the receptacle.

6. The camera as claimed in claim 1 wherein the memory card includes power contacts, and the camera control stage further includes a power supply for providing power to the memory card through the power contacts when the memory card is fully inserted into the receptacle.

7. The camera as claimed in claim 1 wherein the memory card includes clock signal contacts, and the camera control stage further provides clocking signals to the memory card through the clock signal contacts when the memory card is fully inserted into the receptacle.

8. The camera as claimed in claim 1 wherein the memory card provides at least one image sensor parameter selected from the group consisting of resolution, size and aspect ratio to the camera control stage for appropriately adjusting optical object to image plane conjugates of the optical system according to the type of image sensor on the memory card.

9. A film camera adapted for electronically capturing an image, said camera comprising:
a camera enclosure including a film drive for positioning a photographic film in a first image exposure plane within the enclosure;
an optical system including one or more lens elements defining an optical path for forming the image on the first image plane;
a receptacle within the enclosure for receiving a removable memory card through an exterior opening in the enclosure and guiding the memory card into the optical path, wherein said memory card includes an image sensor, a memory device for storing one or more images captured by the image sensor when it is located in the optical path, and an electronic interface for transferring an image signal from the image capture card;
a digital display on the camera for displaying an image signal captured by the image sensor and transferred to the display via the electronic interface when the memory card is fully inserted into the receptacle; and
means for sensing the presence of the memory card in the optical path in order to activate the digital display.

10. The camera as claimed in claim 9 wherein the image sensor produces a still image and the digital display is used to display the still image after it has been captured by the image sensor.

11. A film camera adapted for electronically capturing an image, said camera comprising:
a camera enclosure including a film drive for positioning a photographic film in a first image exposure plane within the enclosure;
an optical system including one or more lens elements defining an optical path for forming the image on the first image plane;
a receptacle within the enclosure for receiving a removable memory card through an exterior opening in the enclosure and guiding the memory card into the optical path, wherein said memory card includes an image sensor and a memory device for storing one or more images captured by the image sensor when it is located in the optical path;
a light lock associated with the receptacle for preventing entry of unwanted light into the camera through the exterior opening; and
a camera control stage responsive to the presence of the memory card in the receptacle for adjusting the optical system to form the image at a second image plane on a surface of the image sensor and for disabling the film drive, thereby preventing the film from being advanced when the image sensor is used to capture the image.

12. The camera as claimed in claim 11 wherein the receptacle includes a light-tight door preventing entry of light into the camera when the memory card is not in the receptacle.

13. The camera as claimed in claim 12 wherein the receptacle includes means for engaging the memory card and holding it fully into the camera so that the light-tight door may close before the image sensor is used to capture an image.

14. The camera as claimed in claim 11 wherein the receptacle further includes means for initiating the ejection of the memory card from the camera.

15. The camera as claimed in claim 11 wherein the light lock is a light tight baffle that is positioned in front of the first image exposure plane before the memory card is inserted into the receptacle.

16. A film camera adapted for electronically capturing an image, said camera comprising:
a camera enclosure including a film drive for positioning a photographic film in a first image exposure plane within the enclosure;
an optical system including one or more lens elements defining an optical path for forming the image on the first image plane;
a receptacle within the enclosure for receiving a removable memory card through an exterior opening in the enclosure and guiding the memory card into the optical path, wherein said memory card includes an image sensor and a memory device for storing one or more images captured by the image sensor when it is located in the optical path;
a display on the camera for providing camera operating information to a user of the camera; and
means for signaling to the display the presence of the memory card in the receptacle so that the user of the camera may be prepared for a digital capture.

17. The camera as claimed in claim 16 wherein one or more lens elements are interchangeable and the means for signaling initiates a visible signal on the display reminding the user to change a lens element.

18. The camera as claimed in claim 16 wherein the display is a viewfinder and the means for signaling produces a visible signal in the viewfinder.

19. A digital camera adapted for electronically capturing an image, said digital camera comprising:
a camera enclosure;
an optical system including one or more lens elements defining an optical path for forming the image;
a receptacle within the enclosure for receiving a removable memory card through an exterior opening in the enclosure and guiding the memory card into the optical path, wherein said memory card includes an integrated image sensor and memory device for storing one or more images captured by the image sensor when it is located in the optical path;
means for sensing the presence of the memory card in the receptacle with the image sensor in the optical path; and
a camera control stage responsive to the sensing means for controlling operation of the camera.

20. The digital camera as claimed in claim 19 wherein the camera control stage adjusts the optical system to form the image at an image plane on a surface of the image sensor.

21. The digital camera as claimed in claim 19 wherein the memory card includes power contacts, and the camera control stage further includes a power supply for providing power to the memory card through the power contacts when the memory card is fully inserted into the receptacle.

22. The digital camera as claimed in claim 19 wherein the memory card includes clock signal contacts, and the camera control stage further provides clocking signals to the memory card through the clock signal contacts when the memory card is fully inserted into the receptacle.

23. The digital camera as claimed in claim 19 wherein the memory card provides at least one image sensor parameter selected from the group consisting of resolution, size and aspect ratio to the camera control stage for appropriately adjusting optical object to image plane conjugates of the optical system according to the type of image sensor on the memory card.

24. A memory card adapted to be removably inserted through an opening in a camera, said memory card including an image sensor and a memory device both integrated on the card for capturing and storing one or more images when the card is inserted into a camera and the image sensor is located in an optical image-forming path in the camera.

25. The memory card as claimed in claim 24 wherein the memory card is a dual card that is doubly useful with a film camera or a digital camera, said memory card further including a memory controller that senses when the memory card is being used in a digital camera having its own dedicated image sensor, and wherein the memory controller causes the memory device to store images captured by the dedicated sensor rather than the sensor integrated on the memory card.

26. A memory card conforming to a compact flash card standard and usable with an electronic camera that includes a flash card interface, said memory card adapted to be removably inserted through a slotted opening in a camera and including a CMOS image sensor and a flash memory device both integrated on the card for capturing and storing one or more images when the card is inserted into a camera and the image sensor is located in an optical image-forming path in the camera.

27. A method for electronically capturing an image in a film camera, said method comprising the steps of:
positioning a photographic film in a first image exposure plane within the camera;
utilizing an optical system including one or more lens elements to define an optical path for forming the image on the first image plane;
inserting a removable memory card through an exterior opening in the camera and guiding the memory card into the optical path, wherein the memory card includes an integrated image sensor and memory device for storing one or more images captured by the image sensor when it is located in the optical path;
sensing the presence of the memory card in the receptacle with the image sensor in the optical path;
preparing the camera for digital capture by adjusting the optical system to form the image at a second image plane on a surface of the image sensor and disabling the film drive, thereby preventing the film from being advanced when the image sensor is used to capture the image;
initiating an image exposure on the image sensor and subsequently storing the image in the memory device on the memory card; and
removing the memory device from the camera, thereby restoring the film capture capability of the camera.
